(19) United States
(12) Patent Application Publication
(10) Pub. No.: US 2008/0139212 A1
(43) Pub. Date: Jun. 12, 2008

(54) APPARATUS AND METHOD FOR INTEROPERATION OF VARIOUS RADIO LINKS WITH A PICONET LINK IN A WIRELESS DEVICE

(75) Inventors: Xiang Chen, Rolling Meadows, IL (US); Aart Jan Geurtsen, Almere (NL); Gerrit W. Hiddink, Ultrecht (NL); Peijuan Liu, Palatine, IL (US); Ravindra P. Moorut, Port Barrington, IL (US); Harald Van Kampen, Nieuwegein (NL)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/567,744

(22) Filed: Dec. 7, 2006

(51) Int. Cl. H04L 27/28; H04Q 7/20

(52) U.S. Cl. 455/450; 375/267

(57) ABSTRACT

The various embodiments provide a mobile station having at least a first and a second radio transceivers wherein a medium access control (MAC) layer framework coordinates the transmission and reception of the at least a first and a second transceiver systems. In addition, the various embodiments employ asynchronous connectionless links (ACL) for voice traffic on a Bluetooth™ link rather than SCO links. A central scheduler (305) interfaces with a first MAC layer (311) and a second MAC layer (321). By interacting with the MAC layers of both systems, the central scheduler (305) collects traffic information from both PHY layers at the buffer (309), including transmission/reception timing, and Quality of Service (QoS) requirements for voice traffic. Based upon the collected information the central scheduler (305) will schedule transmissions by both systems in a non-time-overlapping manner so as to avoid radio frequency interference.

### FIELD OF THE DISCLOSURE

The present disclosure relates generally to wireless devices having various radio transceivers and more particularly to apparatuses and methods for coping with adjacent band interference between a first and a second or more of the various radio transceivers when operating at the transceivers at the same time.

### BACKGROUND

The coexistence of 802.16 and Bluetooth™ (BT) transceivers within a single multimode mobile device requires consideration of adjacent band interference. In a typical application scenario, as illustrated by FIG. 1, a user of a mobile station 101 may be engaged in an ongoing 802.16 voice connection via an 802.16 base station 105 and 802.16 wireless link 109 and simultaneously use the BT wireless link 107 to connect the mobile station 101, which is BT capable, to a headset 103. Although various radio frequency bands may be employed by radio links such as Bluetooth™ as well as 802.16, the bands may be close enough to cause radio interference between the radio interfaces. For example, as shown in FIG. 2, 802.16 may operate within the 2500-2690 MHz band 203 while BT may operate within the 2400-2483.5 MHz band 201 which is close enough to cause adjacent band interference between the first and second radio transceivers within the mobile station.

The degree of interference may be great enough to cause incorrect packet reception by the radio layers and is thus one of the reasons that a radio frequency (RF) layer only solution is not likely to ensure harmonious coexistence between the transceivers. Perhaps even more problematic is the possible occurrence of simultaneous transmissions on the two frequency bands. Such transmissions may cause radio frequency cross products resulting in RF emissions outside of the regulatory bands, thus potentially violating regulatory requirements. Further, given the current specifications of the respective RF layers, imposing additional stringent requirements would significantly increase the design complexity and cost.

Research has been conducted that focused on the coexistence of 802.11 and BT systems and may be categorized into a first and a second classes of mechanisms, collaborative and non-collaborative. Collaborative mechanisms utilize Medium Access Control (MAC) layer coordination to avoid simultaneous transmission.

One example of a collaborative system proposed uses a shared broadcast control channel wherein each system may in turn broadcast its information such as the carrier frequency, the bandwidth occupied, the duty cycle, the transmit power level and so on. The coexisting transceivers thereby refrain from transmission when their counterpart system is active.

Another example of a collaborative mechanism proposed a centralized controller engine at the MAC layer to monitor BT and 802.11 traffic and allow information exchange between the a first and a second systems. If perfect packet transmission timing could be achieved by the controller engine, simultaneous transmission and/or reception by the a first and a second system could be avoided. Similarly, time division multiple access (TDMA) schemes have been proposed to divide transmission/reception time into 802.11 intervals and BT intervals thereby preventing simultaneous transmissions.

The above proposed systems either prioritized BT voice traffic transmitted over a synchronous connection-oriented (SCO) link with a higher priority than the 802.11 traffic or, as in the proposed TDMA scheme, did not explicitly consider prioritization of voice traffic. Alternative schemes related to co-existing 802.11 and BT transceivers suggested dividing a long 802.11 packet into smaller packets and transmitting the smaller packets so as to mitigate interference with BT SCO communication of a collocated or nearby Bluetooth™-enabled device. However, such RF interference cannot be completely avoided even with smaller packet sizes. Further, Voice over IP (VoIP) packets, are already very small in size, and thus such techniques would provide little improvement.

In any event, it is important to note that none of the schemes above have addressed the support of voice traffic or other real-time traffic simultaneously in both radio systems. If both radio systems support voice traffic, simply deferring the transmission of one system to allow the transmission of the other system is not sufficient.

Within the realm of non-collaborative techniques, an Adaptive Frequency Hopping scheme was proposed to deal with possible interference between 802.11 and BT by detecting the frequencies used by 802.11 networks and allowing a BT transceiver to hop within the pool of unused frequencies. However for 802.16, such techniques may only help reduce interference in a limited way due to the fact that the carrier frequency for 802.16 is typically fixed and frequency hopping by BT needs to account for other in-band interference from WLANs. Thus, the possible range of channels for frequency hopping may be narrow.

Another known non-collaborative technique is to allow BT SCO links the flexibility of choosing transmission timing in a dynamic manner. For this purpose, a new packet format called EV3 was created. Compared to HV3 packets that occur in fixed time slots, EV3 packets may be deferred by up to four time slots, or equivalently, 2.5 ms. However, this approach is not supported in the BT standard.

Approaches that combine both collaborative and non-collaborative mechanisms, have also been proposed. However support of real-time traffic, such as voice traffic, spanning a first and a second network, has not been considered in conjunction with such approaches.

Other proposed solutions involve locating transmission gaps in one communication standard wireless link, and seizing the gaps as opportunities for transmission by the second wireless link. Such solutions were discussed within the context of WCDMA and TDMA GPRS/EGPRS coexistence within a base station equipment and without consideration of delay requirements suitable for the support of voice traffic.

Thus, there is a need for an apparatus and method for solving the coexistence problem between 802.16 and BT in adjacent RF bands within a single device while taking into account relatively simultaneous transmission and reception of voice traffic using the various bands.

### BRIEF DESCRIPTION OF THE DRAWINGS

FIG. 1 is a diagram illustrating a mobile device capable of communicating over an 802.16 wireless interface and also capable of connecting to a Bluetooth™ device such as a headset using a Bluetooth™ wireless connection.

FIG. 2 is radio frequency spectrum diagram showing an example of one of the possible operating bands for Bluetooth™ and 802.16 wherein radio frequency interference between the two radio interfaces may occur due to the closeness of the bands.

FIG. 3 is block diagram illustrating a mobile station architecture having a central scheduler in accordance with the various embodiments, and a remote device that may communicate using an asynchronous connectionless link.

FIG. 4 is a diagram representation of an 802.16 frame having a downlink sub-frame and an uplink sub-frame.

FIG. 5 is a diagram of the 802.16 frame further illustrating active and inactive antenna periods

FIG. 6 illustrates a power saving approach using power saving class type 2 in accordance with various embodiments.

FIG. 7 is a timing diagram illustrating time collisions that may occur between an 802.16 transceiver and a Bluetooth™ transceiver when voice is transmitted using SCO links.

FIG. 8 is a timing diagram illustrating scheduling of the 802.16 and Bluetooth™ transceivers incorporating 802.16 sleep mode in accordance with an embodiment.

FIG. 9 is a timing diagram illustrating a scenario having additional BT downlink transmission due to variations in 802.16 base station scheduling, in accordance with various embodiments.

FIG. 10 is a flow chart showing operation of a mobile station central scheduler in accordance with various embodiments.

FIG. 11 is a block diagram illustrating central system timing for the various mobile station modems in accordance with some embodiments.

FIG. 12 is a flow chart illustrating a method of operation in accordance with an embodiment.

FIG. 13 is a flow chart illustrating a method of operation in accordance with an embodiment.

### DETAILED DESCRIPTION

The various embodiments herein disclosed provide a mobile station having at least a first and a second radio transceivers wherein a medium access control (MAC) layer framework coordinates the transmission and reception of the at least a first and a second transceiver systems. In addition, the various embodiments employ asynchronous connectionless links (ACL) for voice traffic on a Bluetooth™ link rather than SCO links.

Turning now to FIG. 3, an architecture of a mobile station 300 having a multimode operation capability and capabilities in accordance with the various embodiments is illustrated. In some embodiments the mobile station 300 will have various processors such as an applications processor 301.

The application processor may also comprise a central scheduler 305, in accordance with the various embodiments which interfaces with various MAC layers 313 such as MAC I, MAC II and MAC III. For example, MAC I may correspond to a Bluetooth™ physical layer PHY I 311 and MAC II may correspond to an 802.16 physical layer PHY II 321. By interacting with the MAC layers of both systems, the central scheduler 305 collects traffic information such as 802.16 and BT traffic information, at the buffer 309 including transmission/reception timing, and Quality of Service (QoS) requirements for voice traffic. The data buffers 309 may be coupled to the MAC layer. Based upon the collected information the central scheduler 305 will schedule transmissions by both systems in a non-time-overlapping manner.

The multimode mobile station 300 may have connections to a Bluetooth™ capable peripheral such as remote device 302, and a base station (not shown in FIG. 3). Based upon such typical connections it is advantageous in the various embodiments to designate the mobile station 300 as the master in the Piconet formed by the remote device 302 and the mobile station 300, as the mobile station 300 has access to knowledge that will help make the scheduling decisions, such as the traffic situation and QoS requirement of, for example, a BT link and an 802.16 link.

The remote device 302, which may act as a slave device, such as a Bluetooth™ slave device in some embodiments, will comprise a physical layer such as PHY I 329 and may also have a corresponding MAC layer 331, Logical Link Controller (LLC) 333, etc., if appropriate for the device type. Further, the remote device may have data buffers 335 for storing queued data which may include voice traffic. Also, in the various embodiments, the remote device 302 will communicate with the mobile station 300 using an asynchronous connectionless link (ACL) 327.

From the perspective of the 802.16 network, the base station is responsible for the scheduling of downlink and uplink transmissions. In other words, the base station will determine the specific timing for the mobile station 300 transmission and reception.

Returning to FIG. 3, in the mobile station of the various embodiments, the central scheduler 305 is implemented based on a slot-based reservation system architecture. The slot-based reservation system consists of the following components: the central scheduler 305 that resides in the mobile station 300, or within an applications processor 301, ‘above’ the modems of both radio technologies; various MAC layers corresponding to respective radio technologies such as 802.16 and Bluetooth™ such as MAC layer 313, MAC I, MAC II, and MAC III. Further, each radio technology comprises a Physical layer (PHY) such as PHY I 311, PHY II 321 and PHY III 323, respectively. Likewise MAC II corresponds to PHY II 321, while MAC III corresponds to PHY III 323. The respective MAC and Physical layers make up the control functionality of the respective radio technology transceivers within the mobile station. The mobile station may also comprise a Logical Link Controller (LLC) 317, an IP layer 318, a Transport layer 319 (for example using Transport Control Protocol/User Datagram Protocol (TCP/UDP)), an application layer such as VoIP 307 and possibly various other layers. The data buffer or data buffers 309 may be coupled to the MAC layers 313, or some other appropriate coupling, and may store data, voice, and various traffic information.

It is to be understood that FIG. 3 is exemplary of the components necessary for realizing the various capabilities disclosed herein with respect to the embodiments of a mobile station and that other components are, or may be, present within a mobile station that are not shown in FIG. 3 and that such other components need not be illustrated as they are readily understood as being, or possibly being, present by one of ordinary skill, and that a mobile station having such other components remains within the scope of the various embodiments having the components and purposes disclosed with respect to FIG. 3.

Returning to FIG. 3, each MAC layer section, such as MAC I further comprises a scheduling agent 315, which assists the central scheduler 305, and that resides in the modems of each radio technology. A protocol 316 between the scheduling agent 315 and the central scheduler 305, is also present which is used to allow a modem to add or remove itself from the schedule, convey requests for pieces of airtime from the modems (i.e. the MAC layer scheduling agents 315) to the central scheduler 305, convey cancellations of pieces of airtime, and convey responses from the central scheduler 305 back to the modem.

It is to be understood that the term “modem” as used throughout herein includes the radio transceiver equipment present within the mobile station 300, and all necessary processors and processing layers for operation such as, but not limited to, a MAC layer, a Physical (PHY) radio layer, a Base Band control layer, Logical Link Control (LLC), etc. as would be necessary for proper mobile station operation and such that the terms “modem” and “transceiver” may be used interchangeably herein throughout for simplicity of explanation of the various embodiments and related operations thereof.

Returning to FIG. 3, the scheduling agents such as scheduling agent 315 thus decide when to send the various scheduling messages to the central scheduler 305 and also respond to messages from the central scheduler 305. The scheduling agent 315 also interfaces with the PHY layer, for example PHY I 311, to control when to receive data or when to force or avoid transmission.

A common system time is employed by all modems present, thereby allowing the central scheduler 305 to define a time schedule that provides input to all modems on the times at which transmission and/or reception is allowable. The architecture represented by FIG. 3 may be easily extended to accommodate the coexistence of multiple technologies within a single device.

Thus in accordance with the various embodiments, the central scheduler 305 grants modems exclusive access to the air interfaces, with the objective that no other modem is either receiving a message or transmitting a message at that specific time.

The various scheduling agents, such as scheduling agent 315 thus “plan” their receptions and transmissions only in time slots where access to the air is granted to them by the central scheduler 305. However, it is understood that this may not always be possible because the various modems in the mobile station only have limited influence on the transmit/receive pattern employed by the wireless protocols.

Therefore, in those cases where simultaneous receive and transmit actions occur, the impact will be a lost packet. It is assumed in the various embodiments that an ARQ mechanism will compensate for such lost packets. In the case of simultaneous transmissions, in an alternative embodiment, a hard-wired radio disable solution may be implemented in the enable/disable interconnect logic 325.

As previously mentioned, all modems as well as the central scheduler 305 must have a common sense of time for the mobile station to work properly. The central timing may be either a continuous sense of time (real time) or a sense of time based on timeslots of a certain duration. This allows the central scheduler 305 to assign time periods to different modems wherein each modem may transmit/receive according to the schedule. Technologies like 802.16 have a trigger to achieve such synchronization between modems and a scheduler, for example, start of frame.

For Bluetooth, there is an internal clock having a 3.2 kHz rate, resulting in a resolution of 312.5 μs, or half the TX or RX slot length. The clock may be implemented with a 28-bit counter that wraps around at 2²⁸−1. The start of each timeslot may be triggered by an increment in CLK1 while CLK0 is zero (with CLK0 being the LSB ticking once every 312.5 μs).

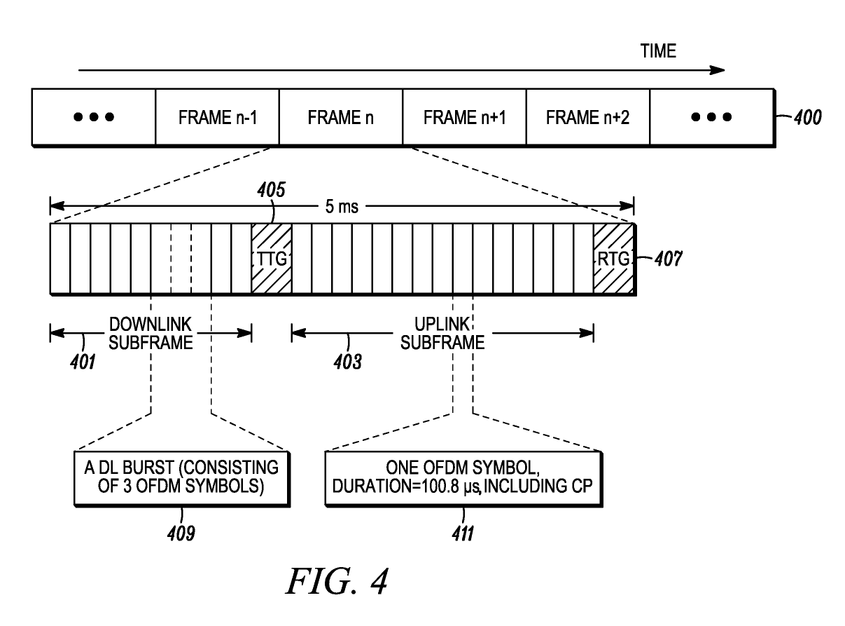

FIG. 4 illustrates the structure of an 802.16 TDD frame 400, where TTG 405 and RTG 407 are a transmit/receive transition gap and receive/transmit transition gap, respectively. In contrast, with respect to the BT radio link for the piconet, the mobile station as the master device has full control of the transmission/reception over the BT link. The BT peripheral device, such as the headset however, is only allowed to transmit packets immediately after the reception of a packet from the mobile station. As a result, the central scheduler 305 will synchronize the BT transmission/reception activities with those of the 802.16 link. More specifically, the central scheduler 305 will schedule the BT transmission and reception when the 802.16 link is unused. In this way, interference may be avoided while not demanding any changes with respect to the 802.16 base station equipment.

Further in accordance with the various embodiments, the sleep mode of 802.16e is utilized to facilitate coexistence and minimize power consumption. Thus, at the beginning of the frame 400, the mobile station must tune in to get the preamble, Frame Control Header (FCH), DL-MAP, and UL-MAP information in order to know when and how to transmit/receive relevant packets in the current, and possibly the next, frame. The DL-MAP specifies the burst information for the current downlink sub-frame 401 while the UL-MAP specifies the burst information for the next uplink sub-frame 403. Both DL-MAP and UL-MAP information are broadcast messages which an associated mobile station is required to decode.

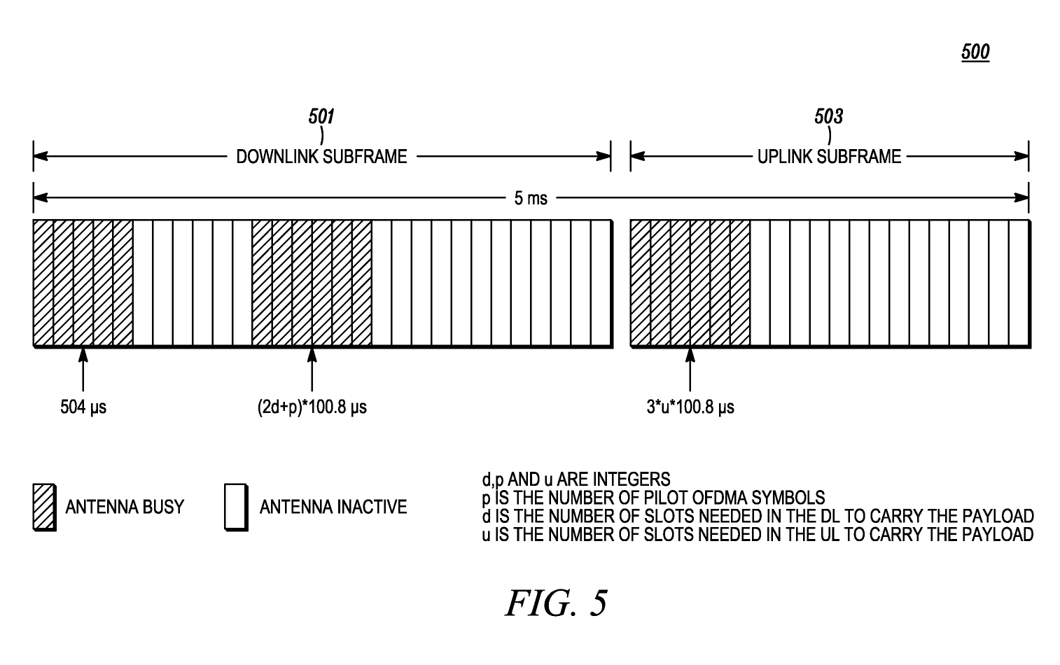

For the UL, the 802.16 standard specifies that the resource allocation must span contiguous slots, which means that the allocation is first done horizontally until reaching the edge of the UL zone, then continuing from the first UL OFDMA symbol of the next sub-channel. FIG. 5 depicts the active and inactive periods of the mobile station antenna in one frame 500 where the mobile station is scheduled for both the DL and UL. As previously discussed, a normally active mobile station needs to tune in the preamble, FCH, DL-MAP and UL-MAP information contained in every frame. However, for VoIP traffic, it is not likely that there is scheduled transmission and reception in every frame. In such cases, it would be beneficial to skip listening to the preamble and MAP portion of some frames, and only listen to the preamble and MAP portion of frames relevant for the mobile station.

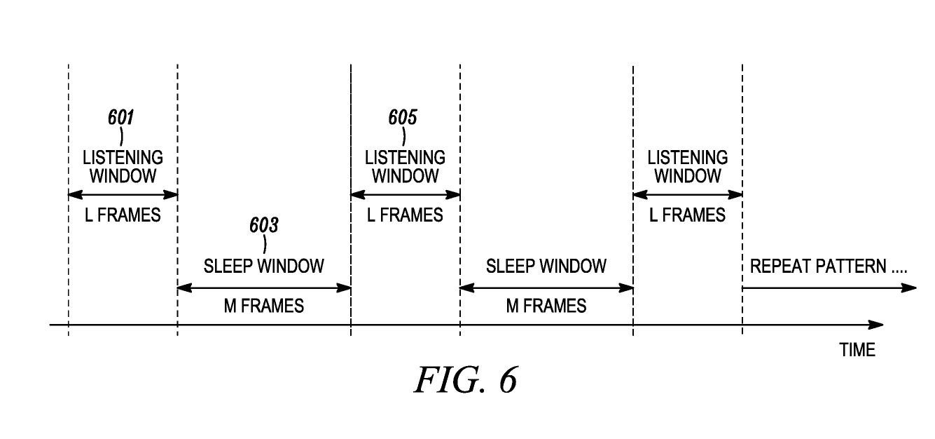

In this case, the time freed up from 802.16 WiMAX receptions may be used by the BT link without any RF interference. In the embodiments, power saving class of type 2 may be used to achieve this effect. Although the 802.16 WiMAX Mobility Profile only specifies the need to support power save class type 1, the characteristics of type 2 may be emulated by tuning the power-save class parameters appropriately. Thus, when the power saving class of type 2 is activated, sleep intervals of fixed duration are interleaved with listening intervals in a periodic fashion as shown in FIG. 6.

For the various embodiments, the following parameters are exchanged and agreed upon when power saving class 2 is activated or otherwise emulated by parameter tuning as mentioned above. An initial-sleep window such as window 603 having M frames, wherein M≧1; a listening window, such as 601 and 605 having L frames, wherein L≧1; and a start frame number for the first sleep window. These parameters are defined in terms of the number of frames, 5 ms per frame. Thus, for example, a possible configuration for a VoIP application in accordance with an embodiment may be setting L and M both to 2 frames, resulting in one scheduled packet in each direction every 20 ms.

An added benefit of the embodiments wherein the sleep mode is activated is that power is conserved in the 802.16 WiMAX modem, since a mobile station only has the 802.16 radio components active during the times that there is actual transmission/reception activity relevant for the particular mobile station.

Turning attention now to the BT radio interface, SCO links as specified in the Bluetooth™ standard are designed to support voice traffic whereas asynchronous connectionless (ACL) links are designed to support data traffic. However, carrying voice over ACL links in BT networks has been explored for the sake of increasing BT network throughput. While such studies have shown that the delay of voice traffic is slightly increased if it is transmitted over ACL links as opposed to SCO links, the delay increase is still quite acceptable.

Therefore, in the various embodiments, voice traffic is carried over BT using ACL links. It is known that BT supports uncompressed speech and that a 64 kbps voice channel is allocated through the use of an SCO link. However, using various voice codec techniques, voice may be coded at variable rates lower than 64 kbps. Thus, using a full 64 kbps timeslot/channel of an SCO link to support such low rate voice traffic is not efficient as the reserved time slot cannot be used by other BT devices in the same Piconet. Therefore, by using ACL links in accordance with the various embodiments, the underutilized channel can be used to support data traffic. More importantly, ACL links provide more flexibility in avoiding the time overlapping of transmissions of 802.16 and BT.

For example, in the 802.16 network, VoIP traffic is most appropriately supported by Extended Real-Time Variable Rate Service (ERT-VR). For uplink connections, ERT-VR should be supported by extended real-time Polling Service (ertPS), wherein the transmission is likely to occur at periodic intervals but the length of the transmission period is flexible. If SCO links are used in BT, the transmission timing is also fixed and periodic. Based on each link's transmission periodicity, collisions may be unavoidable regardless how the scheduling is approached.

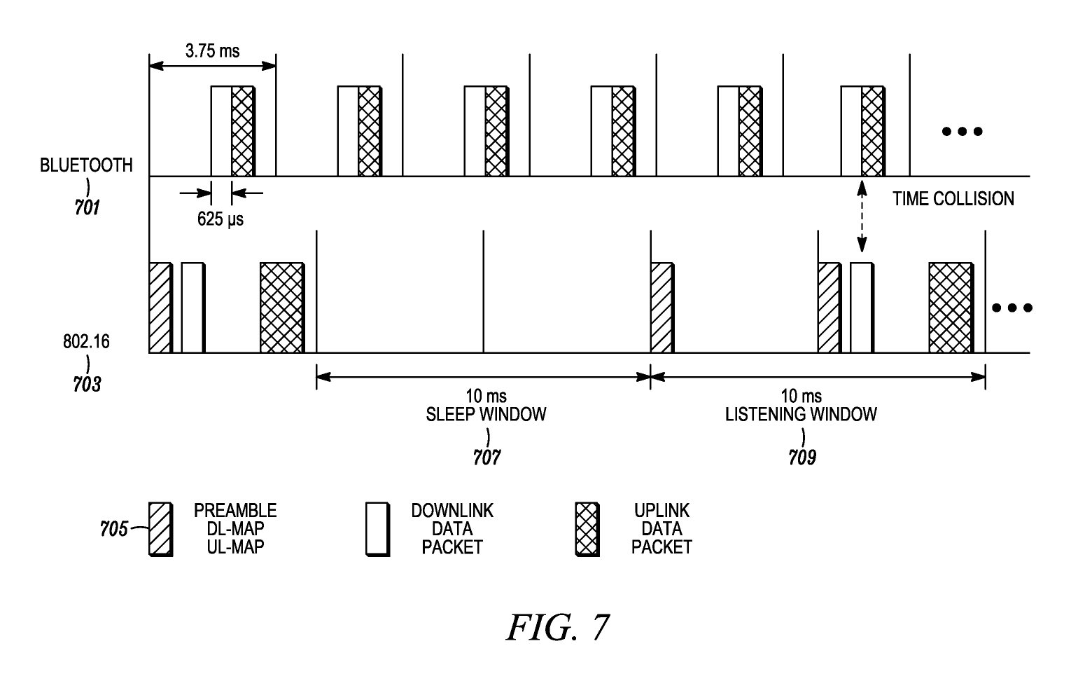

This is illustrated by FIG. 7. In FIG. 7, it is assumed that the 802.16 base station schedules the 802.16 connection 703 every 4 frames and that the voice traffic is transmitted using an HV3 packet format over SCO links on Bluetooth™ radio link 701. Note that to conserve power and avoid listening to the preamble and UL/DL MAP 705, the mobile station may sleep as a power saving class of type 2. Specifically, the mobile station may transmit and receive packets in one frame and sleep for the next a first and a second frames 707 and 709, with the pattern repeating.

However, if ACL links are employed, slot allocation is dynamic and is managed by the mobile station, which is the master in the Bluetooth™ Piconet. Therefore, the central scheduler of the embodiments may determine when to send packets to, and receive packets from, the remote device, such as, but not limited to, a BT headset, without causing collision with the 802.16 link. Therefore, in the various embodiments such collisions, as illustrated in FIG. 7, are avoided.

The central scheduler function of the various embodiments will now be described in further detail. For the example embodiments discussed, it is assumed that both the 802.16 and BT connections have been established and the mobile station serves as the master in the Piconet formed by the mobile station and the remote device such as the BT headset. Also, the example assumes that the modulation and coding scheme (MCS) has been determined between the 802.16 mobile station and the 802.16 base station and hence the corresponding channel capacity is determined as well.

Given the average VoIP codec rates (8 kbps for G. 729) a packetization period of 20 ms, and the associated overhead of each packet including the Real-time Transport Protocol (RTP) header (12 bytes if RTP is used), User Datagram Protocol (UDP) header (8 bytes), Internet Protocol (IP) header (20 bytes), 802.16 MAC header (6 bytes) and security related 4-byte PN (Packet Number) and 8-byte ICV (Integrity Check Value), it is sufficient to use DM3 as the ACL packet format. Note that while the packetization period could be 10, 20, 30, 40, or 60 ms, 20 ms was selected to strike a balance between delay and efficiency. Also note that if the G. 711 coding standard is used, the DM5 packet format would be preferable.

Returning to the present example, each DM3 packet may cover up to 3 time slots, or equivalently 1.875 ms, and carry up to 123 information bytes. Note that for DM3 packets, ⅔ Forward Error Control (FEC) is used. Even though ACL links provide the capability of packet retransmission, FEC is preferable in the various embodiments as FEC reduces the possibility of packet retransmissions and hence packet delay.

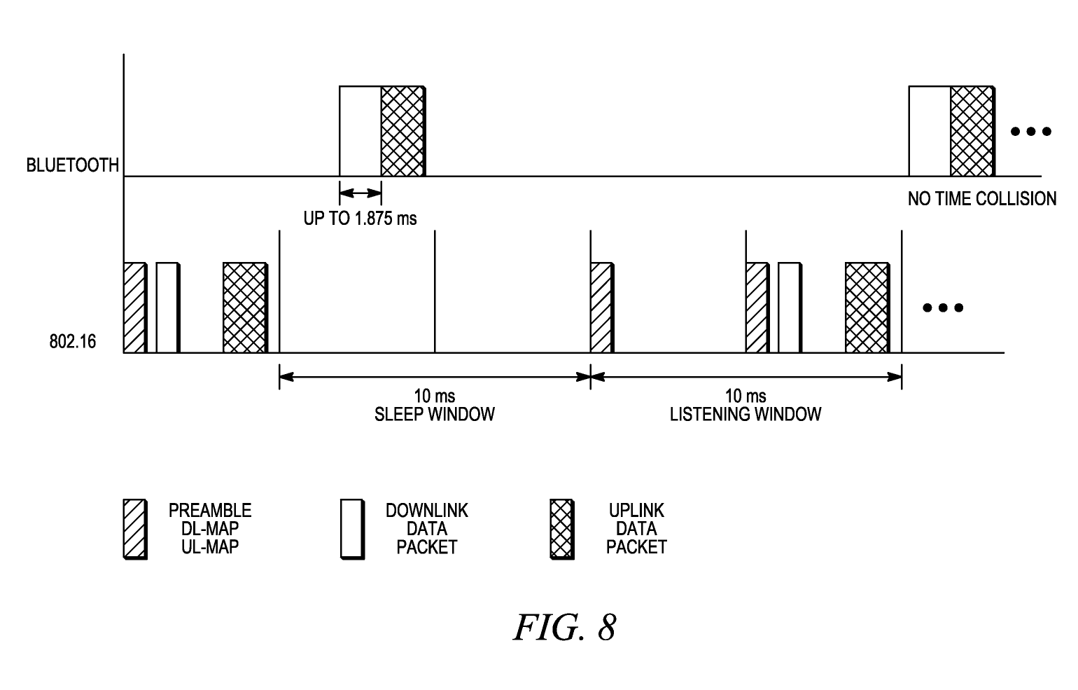

Given the 20 ms packet inter-arrival time, ERT-VR/ertPS service is set up by the 802.16 base station such that every 4 frames, the mobile station and base station will exchange one packet in downlink and uplink. When the transmission to and from the BS is determined, the scheduler will schedule the transmission to and from the BT device when permitted, as shown in FIG. 8, which illustrates the central scheduler function where 802.16 sleep mode is incorporated.

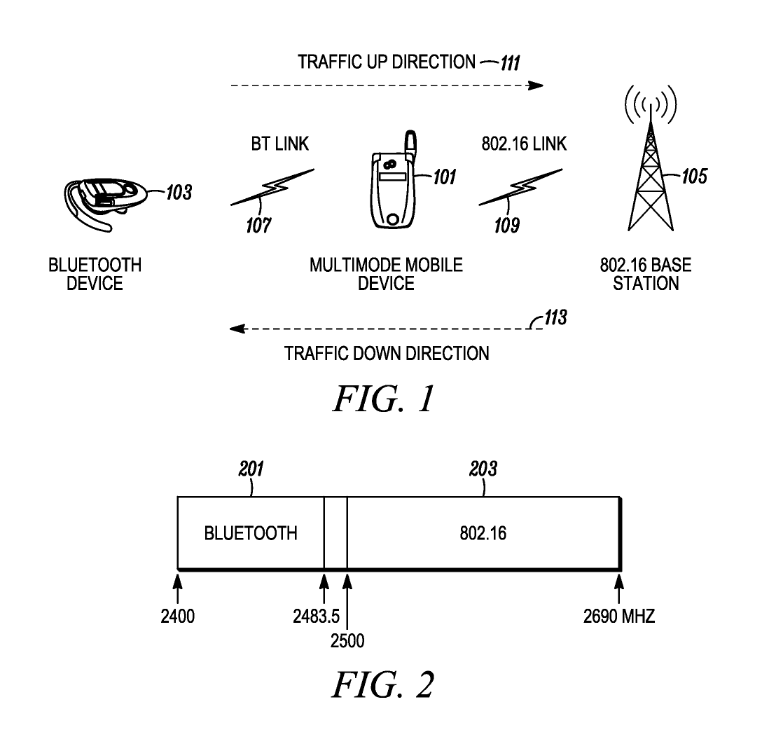

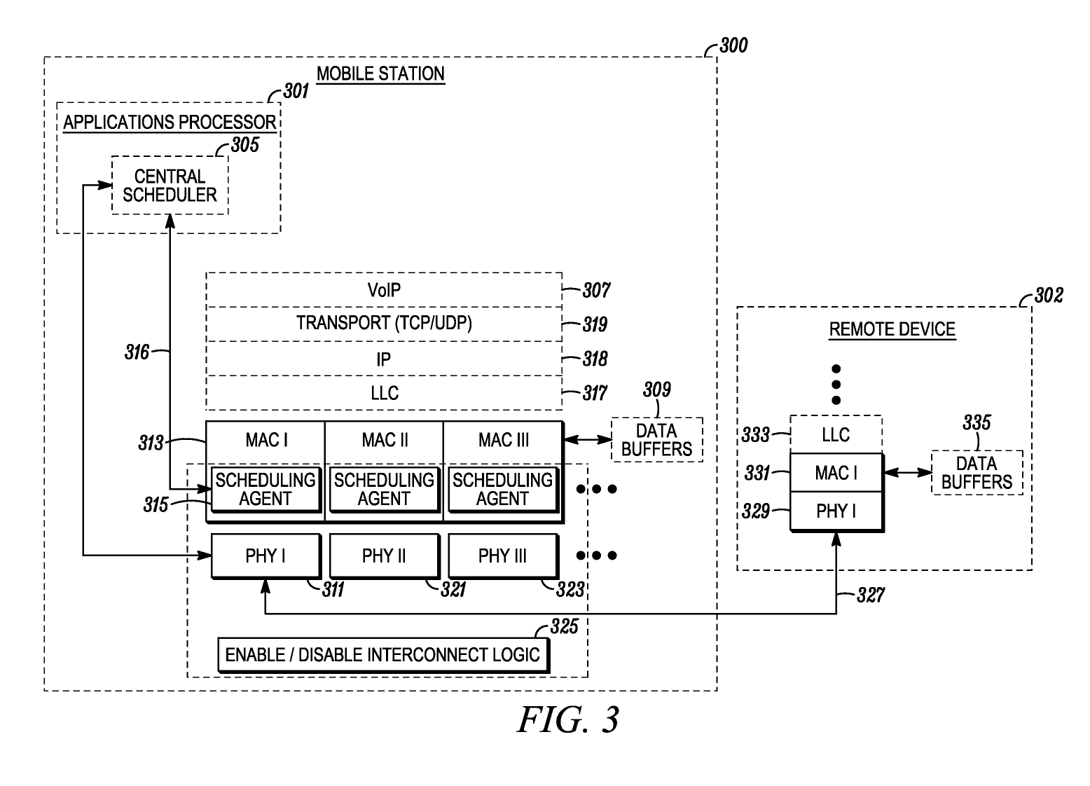

As shown in FIG. 1, for a bidirectional connection, such as, but not limited to, a VoIP connection, the traffic direction from the BT device 103 to the mobile station 101 and then to the base station 105 is designated as the up direction 111 while the opposite direction is designated as the down direction 113. It is to be understood that the amount of traffic in each direction may not be identical.

Specifically, there are three possible scenarios. First, the down direction traffic amount may be the same as up direction traffic amount. In this scenario, the mobile station will transmit one packet to the BT device with the latter sending one packet back following the transmission.

Second, if the up direction traffic amount is larger than down direction traffic amount, the mobile station must poll the BT device even though the mobile station has no packets to transmit to the BT device. Therefore, the mobile station will send a POLL packet to the BT device without any payload information and wait for a data packet from the BT device.

Third, if the up direction traffic amount is smaller than down direction traffic amount, the BT device may not have a packet to transmit every time that the mobile station transmits a packet to it. In this scenario, the BT device will send a NULL packet back to the mobile station.

In light of the above three scenarios, and in accordance with the embodiments, the mobile station will poll the BT device every 20 ms even if it does not have packets for the BT device.

For the various embodiments, the traffic variation at the mobile station caused by the 802.16 base station scheduling may be coped with in the following way. For the up direction, and with respect to the BT uplink, the mobile station polls the BT device every 20 ms, and thus there will be no packet backlog at the BT device. For the 802.16 uplink, since ertPS service is reserved for every 20 ms, there will be no packet backlog either at the mobile station.

For the down connection, due to the dynamic traffic load from one or more end users connected to the 802.16 base station, packets may accumulate at the base station. Depending on the traffic situation and scheduling algorithm adopted at the base station, the base station may transmit more than one packet (one packet being defined as 20 ms worth of information bits generated by the vocoder, plus headers) to the mobile station in the 802.16 downlink in one frame, in order to reduce packet delay, assuming that the base station continues to transmit once every 20 ms.

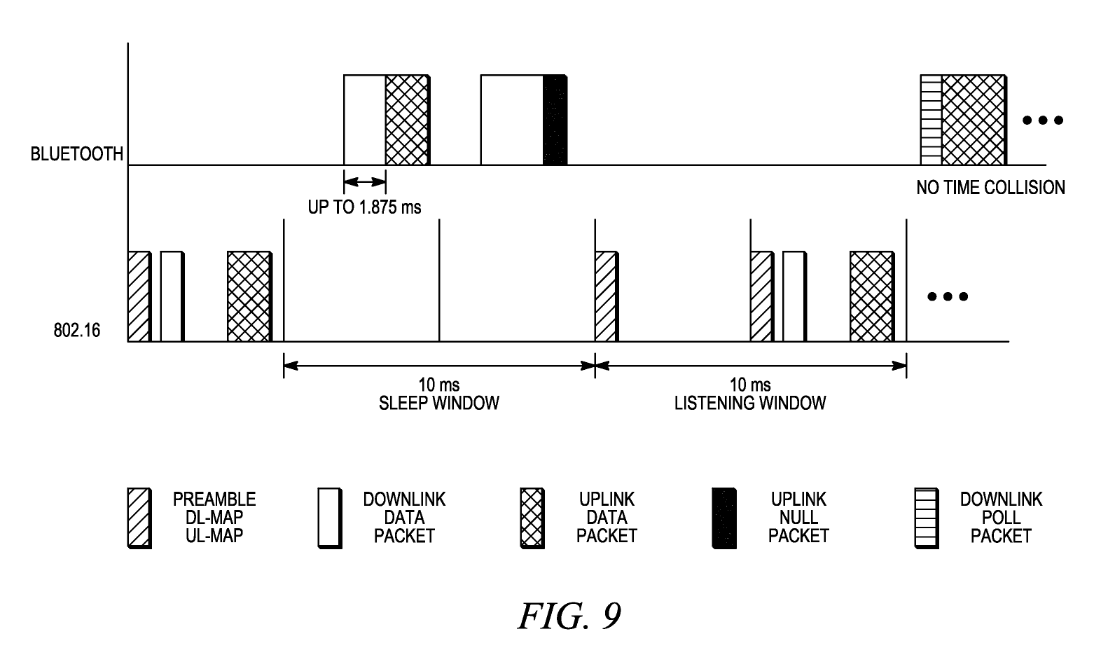

Subsequently, these packets may queue at the mobile station before they reach the BT device if the mobile station still transmits one packet to the BT device every 20 ms. In light of this, the central scheduler of the embodiments will transmit as many packets in the BT downlink as permitted without affecting the transmission/reception to/from the 802.16 base station, or otherwise will transmit until there are no packets destined to the BT device. This phenomenon can be seen in FIG. 9, which illustrates a scenario having additional transmissions on the BT downlink due to base station scheduling variations.

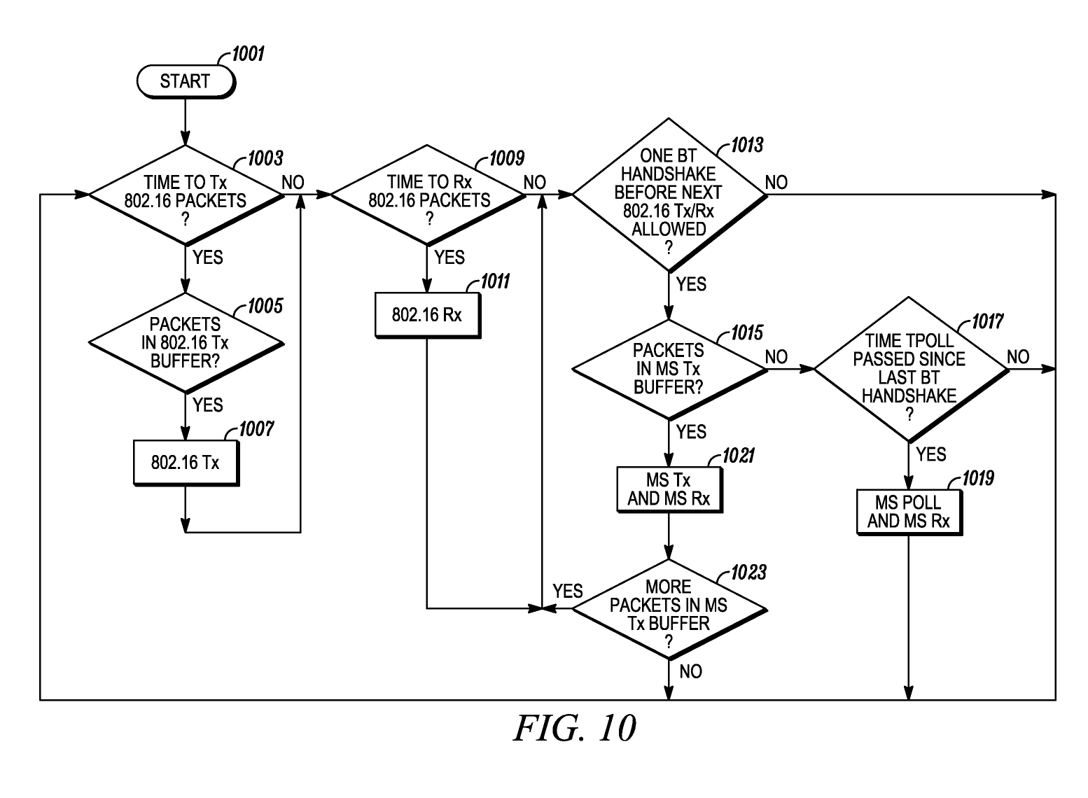

Taking the above points into account, FIG. 10 illustrates scheduling as implemented by the central scheduler in accordance with the various embodiments. Thus, a piconet connection will be established between a mobile station and a remote device, and the method will continue in 1001 where the central scheduler will first check if it is the time to transmit an 802.16 packet in 1003; if so and there is an 802.16 packet in the transmit buffer in 1005, it will allow 802.16 (the 802.16 physical layer and thus the 802.16 transceiver) to transmit such a packet as in 1007. Otherwise, the central scheduler will check if it is the time to receive an 802.16 packet (including the 802.16 control packet such as the preamble and UL/DL MAP) as in 1009; if so, it will allow the 802.16 transceiver to receive a packet in 1011.

The central scheduler will check if the interval from the current time to the next 802.16 TX or RX is long enough to allow a BT handshake in 1013, that is, the mobile station transmitting once and the BT device transmitting once immediately after mobile station's transmission. If the interval is long enough, the BT link, and thus the BT transceiver, will be active.

There are a first and a second scenarios that follow. In the first scenario, if there is a BT packet in the mobile station BT transmit buffer in 1015, the mobile station transmits and then the BT device transmits (i.e. the mobile station receives) in 1021. Afterwards, if there are still BT packets in the buffer in 1023, the central scheduler will go back to 1013 and check if the interval from the current time to next 802.16 TX or RX is long enough to allow a BT handshake and go from there.

In the second scenario, there is no BT packet in the buffer; the central scheduler then will check if time Tpoll has passed since last BT handshake as in 1017; if so, then the mobile station will transmit a POLL packet in 1019 and BT device will transmits after that. Note that Tpoll may be set as the average transmission interval of VoIP minus the 802.16 frame length. For example, if the average interval is 20 ms and the frame length is 5 ms, Tpoll is equal to 15 ms (=20 ms−5 ms). FIG. 9 illustrates one such exemplary scheduling outcome.

Finally, it is to be understood that while in the exemplary embodiment described above, the central scheduler provides for the coexistence of 802.16 and BT in a single multimode mobile device when voice communication is considered, the central scheduler may be easily extended to support data traffic over the BT link. This is because the central scheduler framework of the various embodiments employs ACL links instead of SCO links, which lends itself to the support of data traffic as well as voice traffic.

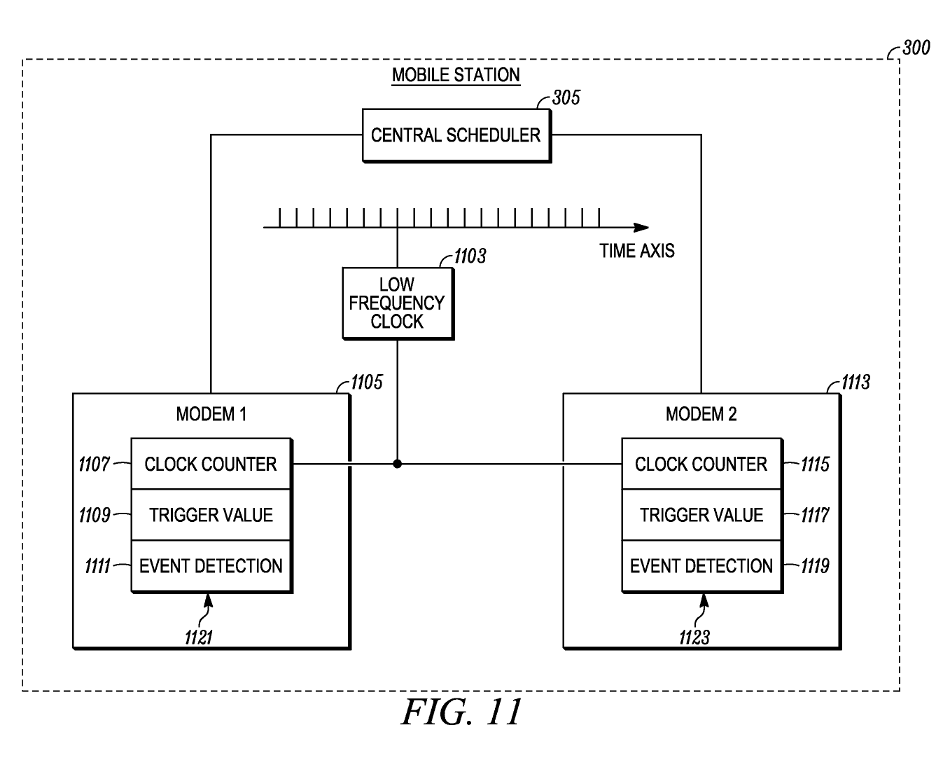

FIG. 11 illustrates one example how central timing may be achieved in the various embodiments. The central scheduler 305, as was discussed with respect to FIG. 3, uses a 32 kHz clock 1103 for both the 802.16 modem 1 1105 and the BT modem 2 1113 that provides a 31.25 μs grid of slots to each. Note that any low-frequency clock would be suitable for the various embodiments however. The timeslot grid together with the sense of time provided by the modem itself, that is, the start of the frame, allows the central scheduler 305 to define a schedule for each modem and enables the modem to know exactly when to transmit/receive. The granularity of 31.25 μs is expected to be sufficient for any of the various embodiments.

The clock 1103 provides input for the Clock Counter registers 1107 and 1115 in each modem. The counters 1107 and 1115 run identical in all modems as a result of a reset procedure at the start of operation. At the detection of a technology-specific event 1121 or 1123 by event detectors 1111 and 1119, respectively, the current value of the Clock Counters 1107 and 1115 is written into an Event Detection register. Such events may be, for example, the start of an 802.16 frame, the start of a BT slot, or other reference point in time. The technology-specific reference points are then communicated to the central scheduler 305. For example, when an 802.16 preamble is received, the preamble timestamp may be used in some embodiments to set the initial value of the clock 1203. Other methods of obtaining a timestamp may be used in the various embodiments such as various technology specific events. For example, where radio interfaces employing a periodic beacon is employed, the beacon may be used to obtain the timestamp as appropriate.

The central scheduler 305 is then able to define a schedule at 31.25 microseconds resolution based on information from the different modems, e.g. start of frame detection, sleep mode patterns, etc. The moments in time for which transmission and reception by a specific technology is allowed (or not allowed) are stored in one or more Trigger Value registers 1109 and 1117. This allows the modems themselves to start and stop operation at 31.25 microseconds resolution.

Regarding the messaging protocol between the scheduler agents and the central scheduler as discussed briefly previously, the commands which are supported by the protocol will now be described. Whenever a modem needs to access the medium (either for transmission or reception) it must ask the central scheduler for permission, using an ‘airtime-request’ message. This message contains the start time, the duration (in number of slots), and the activity (transmit or receive). This information is provided by the modem. For instance, for an 802.16 WiMAX system, the start time, the duration, and the activity becomes known through the reception and decoding of DL-MAP and UL-MAP messages.

If a modem expects to periodically access the medium, it can send a special periodic ‘airtime-request’ to the central scheduler. This message (which only needs to be transmitted once) contains the start time and the duration (in number of slots), and the periodicity (in microseconds).

For periodic requests, the modem has the option to send a schedule-shift-request message to shift the schedule a number of microseconds forwards or backwards in time, if the modem has detected a schedule discrepancy (due to clock drift, for example).

The central scheduler may grant the request, by sending an ‘airtime-response’ message with a ‘granted’ response code back to the modem. The message contains the timing parameters describing the grant. The modem is thereby allowed to access the medium.

Alternatively, the central scheduler may deny the request, by sending an ‘airtime-response’ with a ‘deny’ response back to the modem. The modem is then not allowed to access the medium as indicated in the response. Note that the various embodiments transmit all timing parameters back in the response. The advantage is that the modem does not have to keep state information on its outstanding requests. However, alternative embodiments may make use of a reference ID instead of replying with the parameters.

If the central scheduler grants a periodic request, it is still able to send an ‘airtime-response’ for a specific occurrence of access, for example if a higher priority modem has been granted airtime by the central scheduler. A modem that is denied airtime is then not allowed to access the medium for that specific occurrence. However, it may try again at the next occurrence (or request an additional one-time piece of airtime).

If a modem no longer needs a piece of (granted) airtime, then it can return the reservation to the central scheduler (who may use it for other modems) by ‘airtime-cancel.’

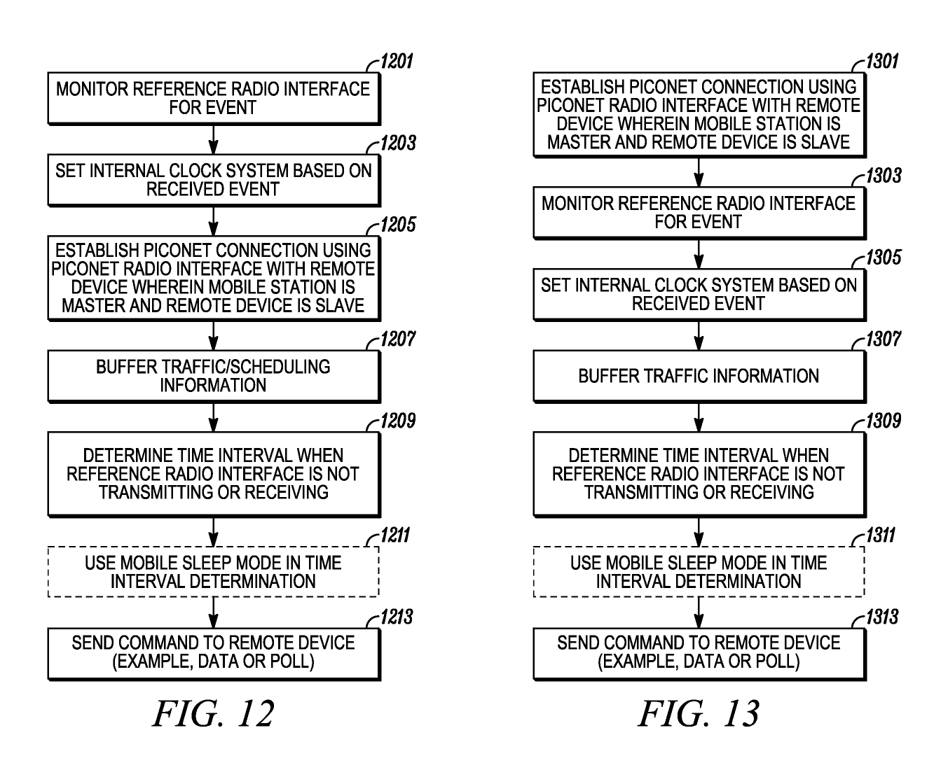

FIG. 12 illustrates an operating methodology in accordance with an embodiment. In 1201, a mobile station monitors a radio interface which is herein referred to as a reference radio interface, which may be for example an 802.16 interface such as OFDMA, and waits for an event. In 1203 the event is detected and an internal clock is set in accordance with the event as a reference. In 1205, the mobile station establishes a piconet connection in which the mobile station is a master device and a remote device is a slave device. In embodiments using Bluetooth™ the connection will be via an ACL link. In 1207, traffic/scheduling information is buffered if appropriate. Note that this buffering may occur prior to 1203 or after 1203 and remain in accordance with the embodiments. In 1209, a time interval is determined which defines when the reference radio interface will not transmit or receive. This time interval may be determined using the traffic/scheduling information buffered in 1207. In some embodiments, a mobile station sleep mode may also be used to determine the time interval as shown in 1211. In 1213, a command may be sent to the remote device to transmit data to it or to receive data from it. For example, a poll, data packet, or other appropriate command may be sent to the remote device.

FIG. 13 illustrates a scenario in which the piconet connection is established first as in 1301. In this scenario, the mobile station may begin to monitor the reference radio interface in 1303 and set, or if appropriate, reset the internal clock accordingly as in 1305. Traffic information may then be buffered in 1307, and an appropriated time interval may be determined as in 1309. Similar to FIG. 12, a sleep mode may be used to determine the time interval in 1311 and in 1313, a command may be sent to the remote device to transmit data to it or to receive data from it.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a wireless mobile station, said method comprising:
monitoring a reference radio interface for an event;
establishing a piconet connection between said mobile station and at least one remote device, said mobile station being a master device, and wherein said piconet connection is an asynchronous connectionless link over a piconet radio interface;
determining, from said reference radio interface event, a time interval for which voice or data packets of said piconet radio interface may be transmitted or received, said time interval defining a period within which said reference radio interface is not transmitting and not receiving; and
sending a command to said at least one remote device, said command enabling said remote device to perform one of transmitting or receiving during said time interval.

2. The method of claim 1, further comprising:
establishing said piconet connection using a packet format applying a ⅔ forward error correction.

3. The method of claim 1, further comprising:
buffering voice or data traffic information for said piconet radio interface and said reference radio interface in a buffer, said voice or data traffic information including transmission and reception timing information, and quality of service requirements for said reference radio interface; and
wherein determining, from said reference radio interface, a time interval for which voice or data packets of said piconet radio link may be transmitted or received, further comprises evaluating said transmission and reception timing information from said buffer.

4. The method of claim 1, wherein monitoring a reference radio interface further comprises:
detecting the beginning of a radio interface frame of said reference radio interface and obtaining a preamble, said preamble including a downlink schedule information and an uplink schedule information.

5. The method of claim 1, wherein determining, from said reference radio interface, a time interval for which voice packets of said piconet radio interface may be transmitted or received, said time interval defining a period within which said reference radio interface is not transmitting and not receiving, further comprises determining a sleep time interval when said mobile station is in a sleep mode for said reference radio interface.

6. The method of claim 1, wherein establishing a piconet connection between said mobile station and at least one remote device, said mobile station being a master device, and wherein said piconet connection is an asynchronous connectionless link over a piconet radio interface, further comprises supporting voice traffic over said asynchronous connectionless link.

7. The method of claim 1, wherein an end-to-end real-time communication link is established between said at least one remote device, via said piconet radio interface to said mobile station, and at least a second remote device, via said reference radio interface to said mobile station.

8. The method of claim 1, wherein said piconet radio interface is Bluetooth™ and said reference radio interface is an 802.16 OFDMA radio interface

9. The method of claim 3, wherein sending a command to said at least one remote device, said command enabling said remote device to perform transmitting during said time interval, further comprises sending a poll packet to said remote device.

10. A mobile station comprising:
at least a first and a second radio transceivers, each transceiver having an associated respective first and second Medium Access Control (MAC) layer scheduling component;
at least one processor coupled to said first and said second radio transceivers; said processor having a central scheduler, said central scheduler coupled to said first and said second MAC layer scheduling components of said first and said second radio transceivers, and wherein said central scheduler is configured to:
control transmission and reception of voice data over an asynchronous connectionless link of an established piconet connection between said mobile station and at least one remote device, said mobile station being a master device, wherein said piconet connection is via said first radio transceiver and a corresponding first radio interface;
monitor a second radio interface corresponding to said second radio transceiver;
determine, from said second radio interface, a time interval for which voice packets of said first radio interface may be transmitted or received, said time interval defining a period within which said second radio transceiver is not transmitting and not receiving; and
send a command to said at least one remote device, said command enabling said remote device to perform one of transmitting or receiving during said time interval.

11. The mobile station of claim 10, wherein said central scheduler is further configured to:
buffer voice traffic information for said first radio transceiver and said second radio transceiver in a buffer, said voice traffic information including transmission and reception timing information, and quality of service requirements for said second radio interface; and
wherein said mobile station will determine, from said second radio interface, a time interval for which voice packets of said first radio interface may be transmitted or received, by evaluating said transmission and reception timing information from said buffer.

12. The mobile station of claim 10, wherein said central scheduler is further configured to:
obtain a downlink schedule information and an uplink schedule information from an OFDMA frame preamble received by said second radio transceiver.

13. The mobile station of claim 10, wherein said central scheduler is further configured to:
determine, from said second radio interface, a time interval for which voice packets of said first radio interface may be transmitted or received, said time interval defining a period within which said second radio transceiver is not transmitting and not receiving, by further determining a sleep time interval when said mobile station is in a sleep mode for second radio interface.

14. The mobile station of claim 10, wherein said central scheduler is further configured to support voice over said asynchronous connectionless link.

15. The mobile station of claim 10, wherein said central scheduler is further configured to send a command to said at least one remote device, said command enabling said remote device to perform one of transmitting or receiving during said time interval, by first checking said buffer to determine whether voice packets for said first radio interface are stored and wherein said command is sent only if voice packets are stored.

16. The mobile station of claim 10, wherein said first radio transceiver is a Bluetooth™ radio transceiver and said second radio transceiver is an 802.16 radio transceiver.

17. The mobile station of claim 10, further comprising a clock component coupled to said first and said second radio transceivers, and coupled to said central scheduler, wherein said clock component is set using an event trigger wherein said event is detected by said second radio transceiver.

18. The mobile station of claim 12, further comprising a clock component coupled to said first and said second radio transceivers, and coupled to said central scheduler, wherein said clock component is set using a timestamp of said OFDMA frame preamble when said OFDMA frame preamble is received by said second radio transceiver.

19. A mobile station comprising:
at least a first and a second radio transceivers, each transceiver having an associated respective first and second Medium Access Control (MAC) layer scheduling component, wherein said first radio transceiver corresponds to a reference radio interface;
at least one processor coupled to said first and said second radio transceivers; said processor having a central scheduler, said central scheduler coupled to said first and said second MAC layer scheduling components of said first and said second radio transceivers, and wherein said central scheduler is configured to:
monitor said reference radio interface corresponding to said first radio transceiver;
control transmission and reception of voice data over an asynchronous connectionless link of an established piconet connection between said mobile station and at least one remote device, said mobile station being a master device, wherein said piconet connection is via said second radio transceiver and a corresponding second radio interface;
determine, from said reference radio interface, a time interval for which voice packets of said second radio interface may be transmitted or received, said time interval defining a period within which said first radio transceiver is not transmitting and not receiving; and
send a command to said at least one remote device, said command enabling said remote device to perform one of transmitting or receiving during said time interval.

20. The mobile station of claim 19, wherein said central scheduler is further configured to:
buffer voice traffic information for said first radio transceiver and said second radio transceiver in a buffer, said voice traffic information including transmission and reception timing information, and quality of service requirements for said reference radio interface; and
wherein said mobile station will determine, from said reference radio interface, a time interval for which voice packets of said second radio interface may be transmitted or received, by evaluating said transmission and reception timing information from said buffer.
